(19) United States
(12) Patent Application Publication
(10) Pub. No.: US 2016/0249680 A1
(43) Pub. Date: Sep. 1, 2016

(54) ELECTRONIC CIGARETTE SET, ELECTRONIC CIGARETTE AND BATTERY ASSEMBLY THEREOF

(71) Applicant: Qiuming LIU, Shenzhen, Guangdong (CN)

(72) Inventor: Qiuming LIU, Shenzhen, Guangdong (CN)

(21) Appl. No.: 14/118,293

(22) PCT Filed: Sep. 5, 2013
(86) PCT No.: PCT/CN13/82968

§ 371 Date: Nov. 18, 2013

(30) Foreign Application Priority Data
Aug. 16, 2013 (CN) 201320503478.7

(51) Int. Cl. A24F 47/00; H05B 3/00; H01M 10/46; H02J 7/00; H01M 2/10; H01M 2/06

(52) U.S. Cl. CPC A24F 47/008; H01M 2/1022; H01M 2/06; H01M 10/46; H02J 7/0044; H05B 3/0014; H01M 2220/30

(57) ABSTRACT

The present application provides an electronic cigarette and a battery assembly thereof, charging electrodes are arranged on an end surface of an end cap, such that the battery assembly of the electronic cigarette may be directly inserted into a charger to be charged without disassembling an atomizing assembly, therefore the operation is more convenient, and the atomizing assembly is less likely to be lost. Furthermore, an exposed surface of each of two charging electrodes arranged at the end cap has similar embossed pattern as that of the end cap, which realizes an effect of simulating a real cigarette end, thereby improving a user experience. The electronic cigarette set according to the present application is convenient and practical.

This application claims the benefit of priority to Chinese patent application No. 201320503478.7 titled “ELECTRONIC CIGARETTE SET, ELECTRONIC CIGARETTE AND BATTERY ASSEMBLY THEREOF”, filed with the Chinese State Intellectual Property Office on Aug. 16, 2013. The entire disclosure of which is incorporated herein by reference.

### FIELD OF THE INVENTION

The present application relates to the technical field of electronic cigarettes, and particularly to an electronic cigarette set, an electronic cigarette and a battery assembly thereof

### BACKGROUND OF THE INVENTION

A conventional electronic cigarette mainly includes a battery assembly and an atomizing assembly, the structure of which is shown in FIG. 1. The battery assembly includes an end cap 11, a switch controller 12, a switch seat 13, a battery 14, a battery sleeve 15, a spring electrode 16, an electrode fixing seat 17, and a connecting seat 18. The atomizing assembly includes a connector 20, an upper electrode 21, an upper insulating ring 22, an atomizing seat 23, an electric heating wire 24, a PVC fiberglass sleeving 25, a tar storage cotton 26, an atomizing sleeve 27, a sealing ring 28 and a mouthpiece cover 29.

Working electrodes of the electronic cigarette are located at a portion where the battery assembly and the atomizing assembly are connected, and also serve as charging electrodes. Hence when charging the battery assembly, the atomizing assembly needs to be disassembled firstly. Due to such structure, the operation is not convenient, and the atomizing assembly is apt to be lost, which may bring a bad using experience for a user.

Therefore, in view of the above situation, a technical problem to be solved presently by those skilled in the art is to provide an electronic cigarette having an improved structure, wherein the battery assembly may be directly inserted into a charger to be charged without disassembling an atomizing assembly, thereby facilitating the operation.

### SUMMARY OF THE INVENTION

In view of this, the present application provides a battery assembly, the battery assembly may be directly inserted into a charger to be charged without disassembling an atomizing assembly, therefore the operation is more convenient, and the atomizing assembly is less likely to be lost.

The present application further provides an electronic cigarette having the battery assembly and an electronic cigarette set.

In order to achieve the above objects, the present application provides the following technical solutions.

A battery assembly, applied in an electronic cigarette having a battery assembly and an atomizing assembly which are detachably assembled, wherein the battery assembly includes two charging electrodes arranged on an end surface of an end cap in the battery assembly, and the two charging electrodes pass through the end surface of the end cap and are electrically connected to two electrodes of a battery in the electronic cigarette respectively.

Preferably, the two charging electrodes are distributed symmetrically with respect to an axis of the battery assembly.

Preferably, a lateral surface of the end cap is arranged with a positioning column capable of cooperating with a corresponding positioning groove in a charger of the electronic cigarette.

Preferably, the positioning column and the two charging electrodes are arranged in a same diameter, and a battery sleeve of the battery assembly is arranged with a mounting groove for cooperating with the positioning column.

Preferably, one of the two charging electrodes is a center electrode arranged on the end cap and located at an axis of the battery assembly, and the other one is a side electrode spaced from the center electrode.

Preferably, an exposed surface of the charging electrode has the same or similar embossed pattern as that of a light cap.

Preferably, the charging electrode is of, but not limited to, a cylindrical shape or a rectangular shape.

An electronic cigarette set includes an electronic cigarette ad a cigarette box, wherein the electronic cigarette has the battery assembly described above.

Preferably, a printed circuit board and a charging seat arranged on the printed circuit board are arranged in the cigarette box, the charging seat is provided to cooperate with two charging electrodes on an end surface of an end cap in the electronic cigarette, and the cigarette box is capable of functioning as a charger of the electronic cigarette.

Preferably, the charger includes a cylindrical electrode for cooperating with the center electrode and an annular electrode for cooperating with the side electrode.

An electronic cigarette includes an atomizing assembly and a battery assembly which share a common outer sleeve, wherein an end cap is arranged at an end of the outer sleeve at a battery assembly side, and the electronic cigarette further includes two charging electrodes arranged on an end surface of the end cap, and the two charging electrodes pass through the end surface of the end cap and are electrically connected to two electrodes of a battery in the electronic cigarette respectively.

As can be seen from the above technical solutions, in an electronic cigarette and a battery assembly thereof according to the present application, the battery assembly of the electronic cigarette may be directly inserted into a charger to be charged without disassembling an atomizing assembly, therefore the operation is more convenient, and the atomizing assembly is less likely to be lost. The electronic cigarette set according to the present application is convenient and practical.

### BRIEF DESCRIPTION OF THE DRAWINGS

For more clearly illustrating embodiments of the present application or the technical solution in the prior art, drawings referred to describe the embodiments or the prior art will be briefly described hereinafter. Apparently, the drawings in the following description are only several embodiments of the present application, and for the person skilled in the art other drawings may be obtained based on these drawings without any creative efforts.

FIG. 1 is a schematic view showing the structure of an electronic cigarette in the prior art;

FIG. 2 is a schematic view showing the structure of an electronic cigarette according to a first embodiment of the present application;

FIG. 3 is an overall view of the electronic cigarette according to the first embodiment of the present application;

FIG. 4 is an exploded view of the electronic cigarette according to the first embodiment of the present application;

FIG. 5 is a schematic view showing the structure of a charging electrode according to the first embodiment of the present application;

FIG. 6 is a schematic view showing the structure of an end cap according to the first embodiment of the present application;

FIG. 7 is a schematic view showing the structure of an end cap according to the first embodiment of the present application;

FIG. 8 is a schematic view showing a charging state of the electronic cigarette according to the first embodiment of the present application;

FIG. 9 is an enlarged view showing the structure of part A in FIG. 8;

FIG. 10 is a schematic view showing the structure of an electronic cigarette according to a second embodiment of the present application;

FIG. 11 is an overall view of the electronic cigarette according to the second embodiment of the present application;

FIG. 12 is an exploded view of the electronic cigarette according to the second embodiment of the present application;

FIG. 13 is a schematic view showing the structure of a charging electrode according to the first embodiment of the present application;

FIG. 14 is a schematic view showing the structure of an end cap according to the second embodiment of the present application;

FIG. 15 is a schematic view showing the structure of an end cap according to the second embodiment of the present application;

FIG. 16 is a schematic view showing a charging state of the electronic cigarette according to the first embodiment of the present application;

FIG. 17 is an enlarged view showing the structure of part B in FIG. 16; and

FIG. 18 is a schematic view showing the structure of a charging seat in FIG. 16.

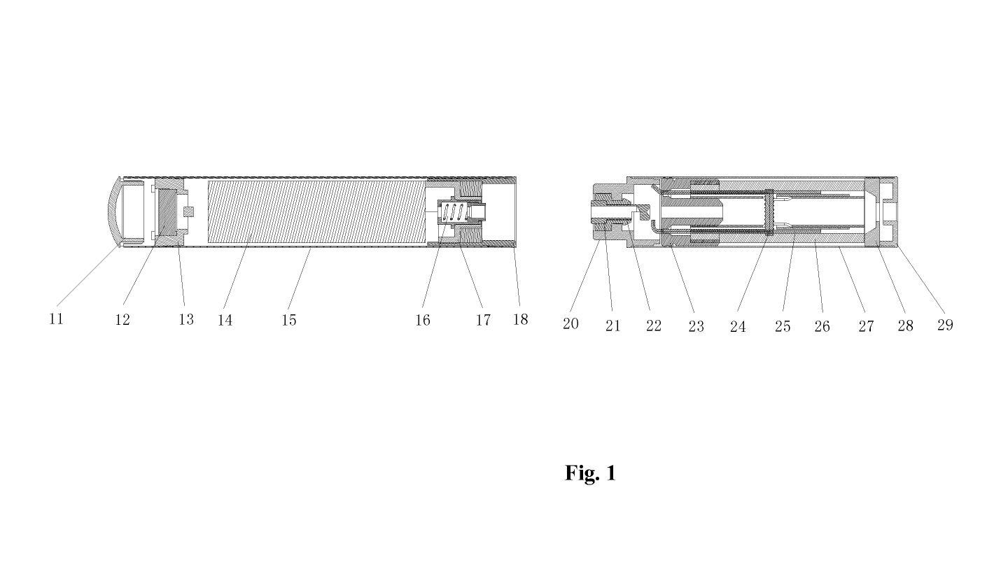

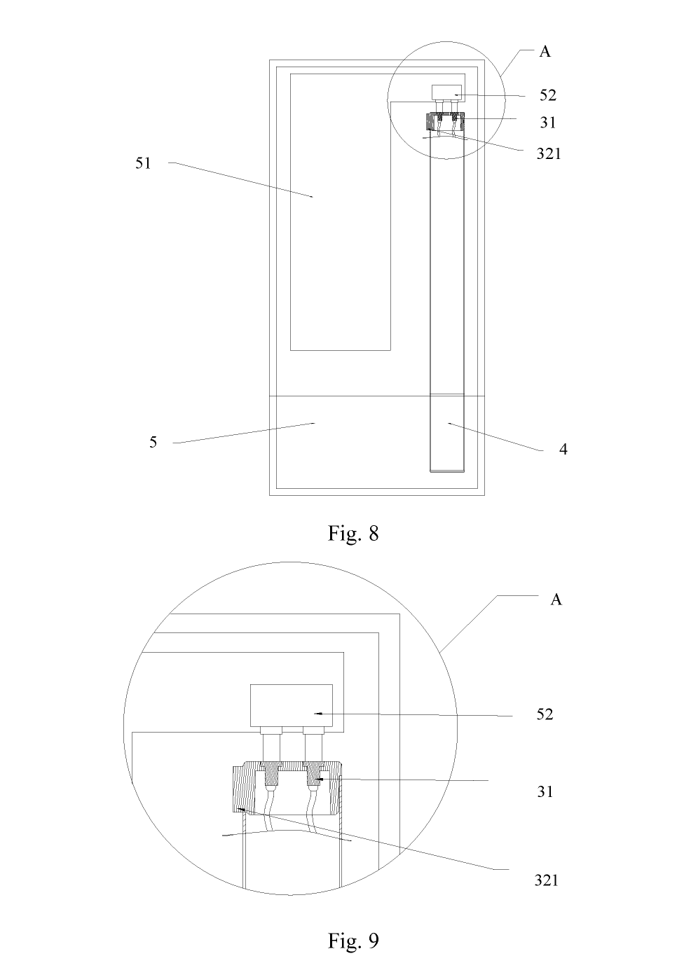

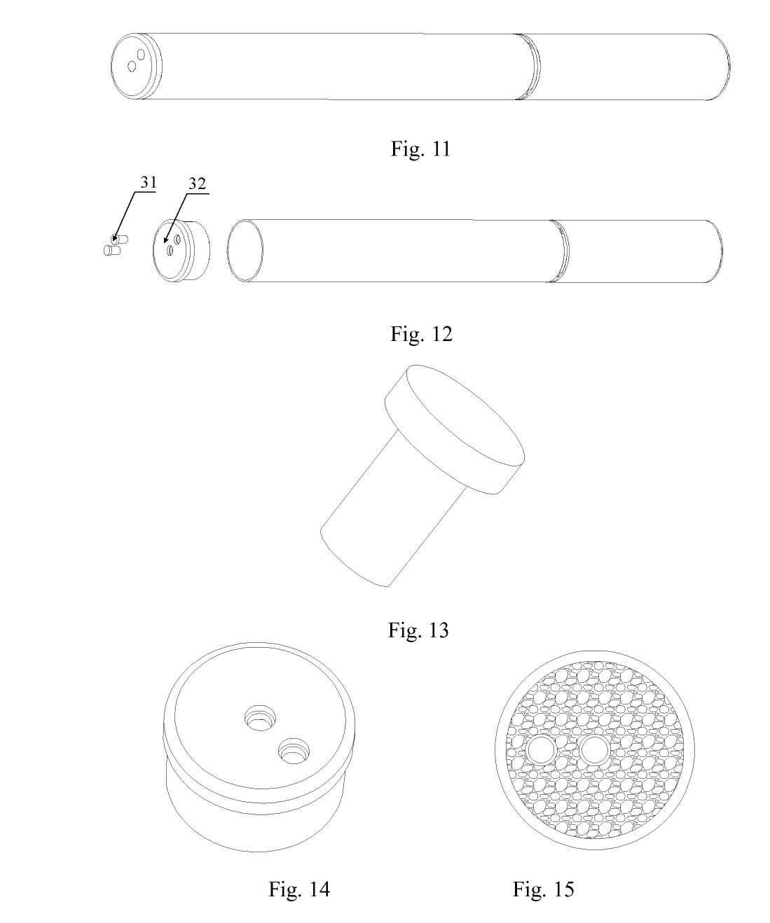

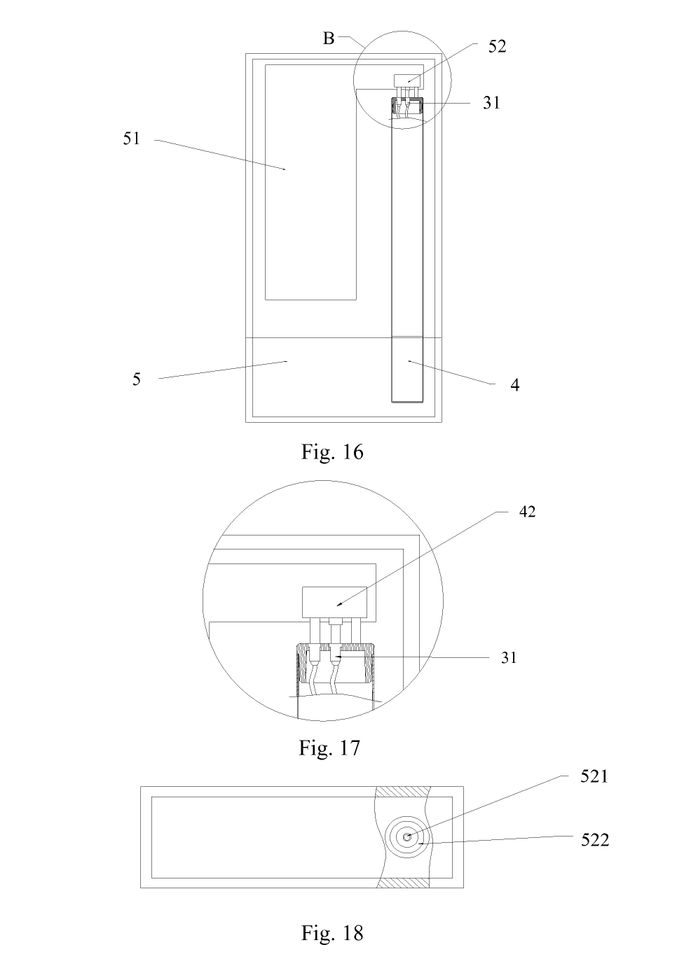

Reference numerals in the FIGS. 1 to 18:

| | | |
|---|---|---|
| 11 end cap, | 12 switch controller, | 13 switch seat, |
| 14 battery, | 15 battery sleeve, | 151 mounting groove; |
| 16 spring electrode, | 17 electrode fixing seat, | 18 connecting seat, |
| 20 connector, | 21 upper electrode, | 22 upper insulating ring, |
| 23 atomizing seat, | 24 electric heating wire, | 25 PVC fiberglass sleeving, |
| 26 tar storage cotton, | 27 atomizing sleeve, | 28 sealing ring, |
| 29 mouthpiece cover; | | |
| 31 charging electrode, | 32 end cap, | 321 locating column, |
| 4 electronic cigarette, | 5 cigarette box, | 51 printed circuit board, |

| | |
|---|---|
| 52 charging seat, | 521 cylindrical electrode, and 522 annular electrode. |

### DETAILED DESCRIPTION OF THE INVENTION

The present application provides an electronic cigarette and a battery assembly thereof, the battery assembly of the electronic cigarette may be directly inserted into a charger to be charged without disassembling an atomizing assembly, therefore the operation is more convenient, and the atomizing assembly is less likely to be lost. The present application is particularly advantageous in such a case that when driving a car, a driver has only one hand free to operate the electronic cigarette.

The technical solutions in the embodiments of the present application will be described clearly and completely hereinafter in conjunction with the drawings in the embodiments of the present application. Apparently, the described embodiments are only a part of the embodiments of the present application, rather than all embodiments. Based on the embodiments in the present application, all of other embodiments, made by the person skilled in the art without any creative efforts, fall into the protection scope of the present application.

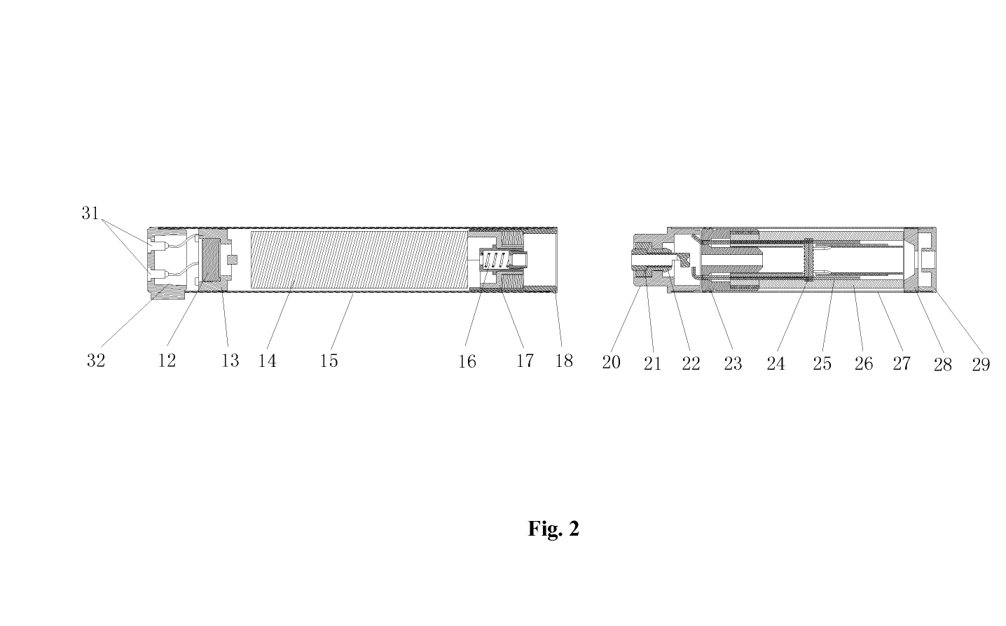

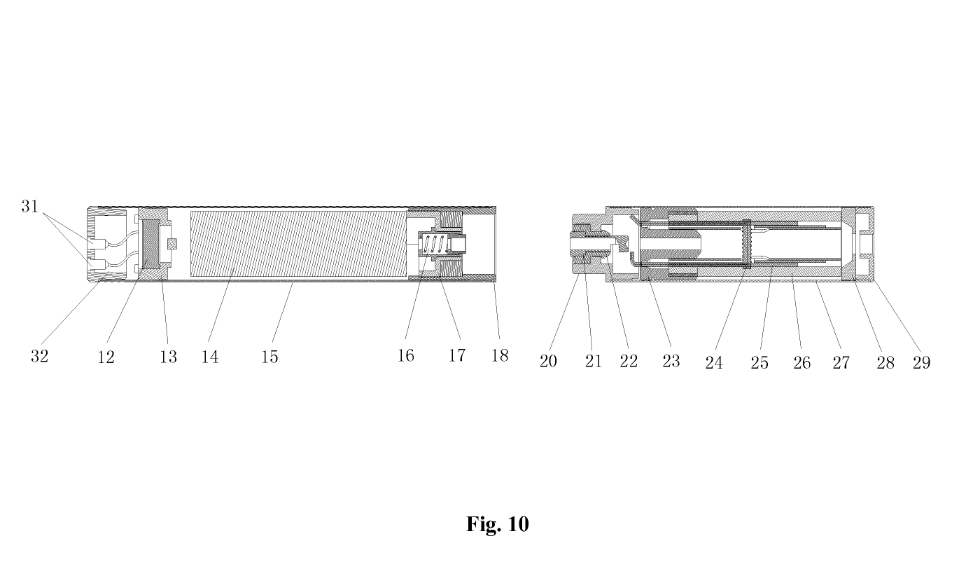

Reference is made to FIGS. 2 to 18. FIGS. 2 to 9 are views of an electronic cigarette according to a first embodiment of the present application; and FIGS. 10 to 18 are views of an electronic cigarette according to a second embodiment of the present application.

The battery assembly according to an embodiment of the present application may be applied not only in an electronic cigarette having a battery assembly and an atomizing assembly which are detachably assembled, but also in an electronic cigarette having a battery assembly and an atomizing assembly which are fixedly connected, i.e., the battery assembly and the atomizing assembly share one outer sleeve. A main improvement of the battery assembly lies in that, the battery assembly includes two charging electrodes 31 arranged on an end surface of an end cap 32 in the battery assembly, and the two charging electrodes 31 pass through the end surface of the end cap 31 and are electrically connected to two electrodes of a battery 14 in the electronic cigarette respectively.

As can been seen from the above technical solutions, according to the embodiment of the present application, the battery assembly of an electronic cigarette may be directly inserted into a charger to be charged without disassembling an atomizing assembly, therefore the operation is more convenient, and the atomizing assembly is less likely to be lost.

In a first embodiment according to the present application, two charging electrodes 31 are distributed symmetrically with respect to an axis of the battery assembly, as shown in FIG. 2. The end surface of the end cap 32 is arranged with through holes cooperating with the two charging electrodes 31, and preferably, the end surface is modified from a conventional curved surface to a flat surface for facilitating the cooperation with the charging seat, and the structure of the end cap is shown in FIG. 6.

For further optimizing the above technical solutions, a lateral surface of the end cap 32 is arranged with a positioning column capable of cooperating with a corresponding positioning groove in the charger of the electronic cigarette. In using, the positioning column may be inserted into the charger along the positioning groove to charge the electronic cigarette, thereby facilitating the operation for the user.

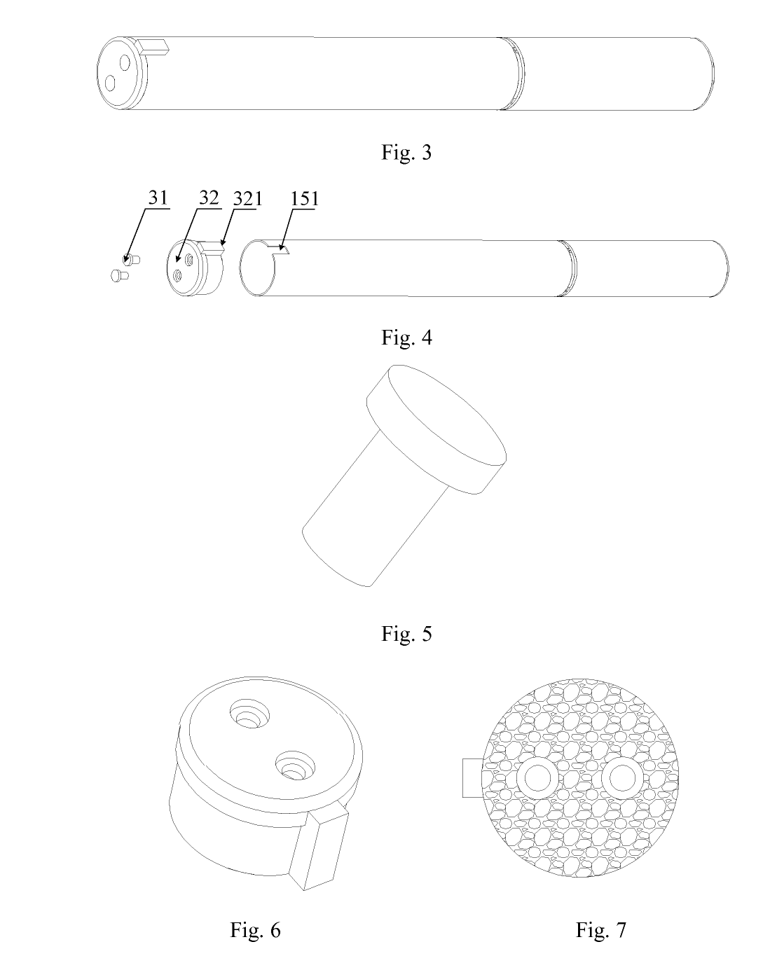

The positioning column and the two charging electrodes 31 may be arranged at a same diameter, a battery sleeve 15 of the battery assembly is arranged with a mounting groove 151 for cooperating with the positioning column 321, and the above structure is shown in FIGS. 3 and 4.

In a second embodiment according to the present application, one of the two charging electrodes 31 is a center electrode arranged at the end cap 32 and located at an axis of the battery assembly, and the other one is a side electrode spaced from the center electrode and arranged around the center electrode, and the structure of the center electrode and the side electrode are shown in FIGS. 10 to 12 and 14. Correspondingly, the charger is arranged with a cylindrical electrode for cooperating with the center electrode, and an annular electrode for cooperating with the side electrode. In this way, the electronic cigarette may be charged by being simply inserted into the charger without aligning the electronic cigarette with the charger, thus the operation is more convenient.

For further optimizing the above technical solutions, an exposed surface of the charging electrode 31 has the same or similar embossed pattern as that of the end cap 32, which forms an effect as shown in FIGS. 7 and 15. An effect of simulating a real cigarette end may be realized by mounting such charging electrodes 31 in the end cap 32, thereby improving a user experience.

The shape of the charging electrode 31 may be, but not limited to, a cylindrical shape or a rectangular shape.

As can be appreciated that, in other embodiments, the two annular electrodes are two circular plated layers arranged on the end surface of the end cap by plating, and the plated layers are connected to two electrodes of the battery by welding through a wire. The end cap is a light cap arranged at an outer side of a head light for simulating cigarette ash.

An embodiment of the present application further provides an electronic cigarette set including an electronic cigarette 4 and a cigarette box 5. A main improvement of the electronic cigarette set lies in that, the electronic cigarette 4 has the above battery assembly, and the battery assembly of the electronic cigarette may be directly inserted into a charger to be charged without disassembling an atomizing assembly, therefore the operation is more convenient, and the atomizing assembly is less likely to be lost.

For further optimizing the above solutions, a printed circuit board 51 (abbreviated as PCB) and a charging seat 52 arranged on the PCB are arranged inside the cigarette box 5, and the charging seat 52 is provided to cooperate with two charging electrodes 31 on the end surface of the end cap 32 in the electronic cigarette 4, therefore the cigarette box 5 may function as a charger of the electronic cigarette 4.

According to an embodiment of this solution, a slot for cooperating with the electronic cigarette 4 is arranged in the cigarette box 5, the charging seat 52 is located at a bottom of the slot. In this way, once the electronic cigarette 4 is placed back into the cigarette box 5, an end cap side of the electronic cigarette 4 may cooperate with the charging seat 52 to perform the charging.

Preferably, the charging seat includes a cylindrical electrode 521 for cooperating with the center electrode, and an annular electrode 522 for cooperating with the side electrode, and the structure of the charging seat is shown in FIGS. 16 to 18.

Differing from the above detachable structure (i.e., two assemblies have their own sleeves, and are connected together), the charging structure in this solution may also be used in an integrated electronic cigarette. The integrated electronic cigarette includes an atomizing assembly and a battery assembly which share one common outer sleeve, and an end cap is arranged at an end of the outer sleeve at the battery assembly side. A main improvement of the integrated electronic cigarette lies in that, the integrated electronic cigarette further includes two charging electrodes arranged on an end surface of the end cap, and the two charging electrodes pass through the end surface of the end cap and are electrically connected to two electrodes of a battery in the electronic cigarette respectively. In conclusion, according to the electronic cigarette and the battery assembly thereof provided by the embodiment of the present application, charging electrodes are arranged on the end surface of the end cap, such that the battery assembly of the electronic cigarette may be directly inserted into a charger to be charged without disassembling an atomizing assembly, therefore the operation is more convenient, and the atomizing assembly is less likely to be lost. Furthermore, an exposed surface of the two charging electrodes arranged at the end cap has similar embossed pattern as that of the end cap, which realizes an effect of simulating a real cigarette end, thereby improving a user experience. The electronic cigarette set according to the present application is convenient and practical.

The above embodiments are described in a progressive manner. Each of the embodiments is mainly focused on describing its differences from other embodiments, and references may be made among these embodiments with respect to the same or similar portions among these embodiments.

Based on the above description of the disclosed embodiments, the person skilled in the art is capable of carrying out or using the present application. It is obvious for the person skilled in the art to make many modifications to these embodiments. The general principle defined herein may be applied to other embodiments without departing from the spirit or scope of the present application. Therefore, the present application is not limited to the embodiments illustrated herein, but should be defined by the broadest scope consistent with the principle and novel features disclosed herein.

1. A battery assembly, applied in an electronic cigarette having a battery assembly and an atomizing assembly which are detachably assembled, wherein the battery assembly comprises two charging electrodes arranged on an end surface of an end cap in the battery assembly, and the two charging electrodes pass through the end surface of the end cap and are electrically connected to two electrodes of a battery in the electronic cigarette respectively.

2. The battery assembly according to claim 1, wherein the two charging electrodes are distributed symmetrically with respect to an axis of the battery assembly.

3. The battery assembly according to claim 2, wherein a lateral surface of the end cap is arranged with a positioning column capable of cooperating with a corresponding positioning groove in a charger of the electronic cigarette.

4. The battery assembly according to claim 3, wherein the positioning column and the two charging electrodes are arranged in a same diameter, and a battery sleeve of the battery assembly is arranged with a mounting groove for cooperating with the positioning column.

5. The battery assembly according to claim 1, wherein one of the two charging electrodes is a center electrode arranged on the end cap and located at an axis of the battery assembly, and the other one is a side electrode spaced from the center electrode.

6. The battery assembly according to claim 1, wherein an exposed surface of the charging electrode has the same or similar embossed pattern as that of a light cap.

7. The battery assembly according to claim 6, wherein the charging electrode is of, but not limited to, a cylindrical shape or a rectangular shape.

8. An electronic cigarette set, comprising an electronic cigarette ad a cigarette box, wherein the electronic cigarette comprises a battery assembly and an atomizing assembly which are detachably assembled, the battery assembly comprises two charging electrodes arranged on an end surface of an end cap in the battery assembly, and the two charging electrodes pass through the end surface of the end cap and are electrically connected to two electrodes of a battery in the electronic cigarette respectively.

9. The electronic cigarette set according to claim 8, wherein a printed circuit board and a charging seat arranged on the printed circuit board are arranged in the cigarette box, the charging seat is provided to cooperate with two charging electrodes on an end surface of an end cap in the electronic cigarette, and the cigarette box is capable of functioning as a charger of the electronic cigarette.

10. The electronic cigarette set according to claim 9, wherein the charger comprises a cylindrical electrode for cooperating with the center electrode and an annular electrode for cooperating with the side electrode.

11. An electronic cigarette, comprising an atomizing assembly and a battery assembly which share a common outer sleeve, wherein an end cap is arranged at an end of the outer sleeve at a battery assembly side, and the electronic cigarette further comprises two charging electrodes arranged on an end surface of the end cap, and the two charging electrodes pass through the end surface of the end cap and are electrically connected to two electrodes of a battery in the electronic cigarette respectively.

12. The electronic cigarette set according to claim 8, wherein the two charging electrodes are distributed symmetrically with respect to an axis of the battery assembly.

13. The electronic cigarette set according to claim 12, wherein a lateral surface of the end cap is arranged with a positioning column capable of cooperating with a corresponding positioning groove in a charger of the electronic cigarette.

14. The electronic cigarette set according to claim 13, wherein the positioning column and the two charging electrodes are arranged in a same diameter, and a battery sleeve of the battery assembly is arranged with a mounting groove for cooperating with the positioning column.

15. The electronic cigarette set according to claim 8, wherein one of the two charging electrodes is a center electrode arranged on the end cap and located at an axis of the battery assembly, and the other one is a side electrode spaced from the center electrode.

16. The electronic cigarette set according to claim 8, wherein an exposed surface of the charging electrode has the same or similar embossed pattern as that of a light cap.

17. The electronic cigarette set according to claim 16, wherein the charging electrode is of, but not limited to, a cylindrical shape or a rectangular shape.
